(19) United States
(12) Patent Application Publication
(10) Pub. No.: US 2017/0056851 A1
(43) Pub. Date: Mar. 2, 2017

(54) INORGANIC NANOPARTICLE DISPERSION LIQUID AND METHOD FOR PRODUCING SAME

(71) Applicant: KANEKA CORPORATION, Osaka-shi, Osaka (JP)

(72) Inventors: Takuto NAGANO, Osaka-shi (JP); Shinsuke AKAO, Settsu-shi (JP)

(73) Assignee: KANEKA CORPORATION, Osaka-shi, Osaka (JP)

(21) Appl. No.: 15/120,258

(22) PCT Filed: Mar. 3, 2015
(86) PCT No.: PCT/JP2015/056186

§ 371 Date: Aug. 19, 2016

(30) Foreign Application Priority Data
Mar. 11, 2014 (JP) 2014-048158

(51) Int. Cl. B01F 17/00; D01F 9/12; C01B 13/14; C01B 31/02

(52) U.S. Cl. CPC B01F 17/005; C01B 31/0273; D01F 9/12; C01B 13/145

(57) ABSTRACT

The objective of the present invention is to provide an inorganic nanoparticle dispersion liquid in which an amount of a surfactant is reduced or in which an inorganic nanoparticle is dispersed with improved dispersion stability, and a production method thereof. The method for producing an inorganic nanoparticle dispersion liquid according to the present invention is characterized in comprising the steps of mixing an inorganic nanoparticle, a cyclic lipopeptide biosurfactant and a medium, and dispersing the inorganic nanoparticle in the medium.

### TECHNICAL FIELD

The present invention relates to an inorganic nanoparticle dispersion liquid in which an amount of a surfactant is reduced or in which an inorganic nanoparticle is dispersed with improved dispersion stability, and a production method thereof.

### BACKGROUND ART

In general, a surfactant is used for dispersing an inorganic fine particle in a medium or dispersing a substance in another substance which is not compatible, such as water and oil. However, in particular, when an inorganic fine particle as a solid is dispersed in a medium, the inorganic fine particle may settle out during storage in some cases. It is therefore preferred that a surfactant has excellent activity to ensure a stability of a dispersion.

As a surfactant used for the above-described purpose, a so-called synthetic surfactant is used rather than a naturally occurring soap component such as a long-chain fatty acid salt in the aspect of a high surfactant activity and production cost.

For example, in the invention described in Patent Document 1, an anionic surfactant is used in addition to a water-soluble polymer to disperse a carbon nanotube in water. In the invention described in Patent Document 2, a surfactant such as an alkylsulfuric acid ester salt is used in combination with urea for the same purpose. In the invention described in Patent Document 3, an anionic surfactant having the specific substituent group is used for the same purpose. In the invention described in Patent Document 4, a surfactant having an aromatic group is used for the same purpose.

However, a synthetic surfactant has various problems. For example, a linear alkylbenzene sulfonate (LAS) has been used on behalf of a branched alkylbenzene sulfonate (ABS), since pollution by bubbles due to ABS became a problem. Nevertheless, LAS has severe bad influence on a human body and the environment. It is said that an alfa-olefin sulfonate (AOS) has the highest toxicity to fishes among surfactants. Recently, the general use of a phosphate salt surfactant has been avoided, since the surfactant causes eutrophication of lake or the like. However, the surfactant is still used for an industrial product.

### PRIOR ART DOCUMENT

### Patent Document

Patent Document 1: JP 2013-082610 A
Patent Document 2: JP 2012-218992 A
Patent Document 3: JP 2010-013312 A
Patent Document 4: JP 2005-263608 A

### DISCLOSURE OF THE INVENTION

### Problems to be Solved by the Invention

As described above, a synthetic surfactant having a high activity is mainly used for a dispersion of an inorganic fine particle. However, an amount of a synthetic surfactant to be used should be reduced as much as possible, since the surfactant has a negative impact on a living body and the environment.

Accordingly, the objective of the present invention is to provide an inorganic nanoparticle dispersion liquid in which an amount of a surfactant is reduced or in which an inorganic nanoparticle is dispersed with improved dispersion stability, and a production method thereof.

### Means for Solving the Problems

The inventors of the present invention made extensive studies to solve the above problems. As a result, the inventors completed the present invention by finding that an inorganic nanoparticle dispersion liquid having excellent dispersion stability can be obtained or an amount of a surfactant to be used can be reduced by using a cyclic lipopeptide biosurfactant as a surfactant, since a cyclic lipopeptide biosurfactant can particularly improve the dispersibility of an inorganic nanoparticle.

Hereinafter, the present invention is described.

[1] A method for producing an inorganic nanoparticle dispersion liquid, comprising the steps of:

mixing an inorganic nanoparticle, a cyclic lipopeptide biosurfactant and a medium, and dispersing the inorganic nanoparticle in the medium.

[2] The method according to the above [1], wherein surfactin represented by the following formula (I) or a salt thereof is used as the cyclic lipopeptide biosurfactant:

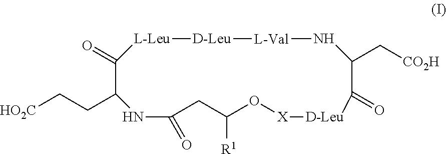

wherein ‘X’ is a residue of an amino acid selected from leucine, isoleucine and valine; and R¹ is a C₉₋₁₈ alkyl group.

[3] The method according to the above [1] or [2], wherein the inorganic nanoparticle is a carbon nanotube, a carbon nanofiber or a metal oxide nanoparticle.

[4] The method according to any one of the above [1] to [3], wherein a concentration of the cyclic lipopeptide biosurfactant in the inorganic nanoparticle dispersion liquid is 0.0005 mass % or more and 1 mass % or less.

[5] An inorganic nanoparticle dispersion liquid,

comprising an inorganic nanoparticle, a cyclic lipopeptide biosurfactant and a medium, and

wherein the inorganic nanoparticle is dispersed in the medium.

[6] The inorganic nanoparticle dispersion liquid according to the above [5], wherein the cyclic lipopeptide biosurfactant is surfactin represented by the following formula (I) or a salt thereof:

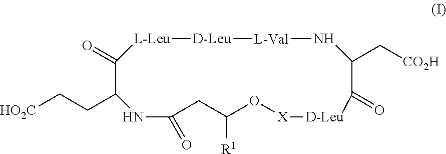

wherein ‘X’ is a residue of an amino acid selected from leucine, isoleucine and valine; and R¹ is a C₉₋₁₈ alkyl group.

[7] The inorganic nanoparticle dispersion liquid according to the above [5] or [6], wherein the inorganic nanoparticle is a carbon nanotube, a carbon nanofiber or a metal oxide nanoparticle.

[8] The inorganic nanoparticle dispersion liquid according to any one of the above [5] to [7], wherein a concentration of the cyclic lipopeptide biosurfactant in the inorganic nanoparticle dispersion liquid is 0.0005 mass % or more and 1 mass % or less.

[9] Use of a cyclic lipopeptide biosurfactant for dispersing an inorganic nanoparticle in a medium to produce an inorganic nanoparticle dispersion liquid.

[10] The use according to the above [9], wherein the cyclic lipopeptide biosurfactant is surfactin represented by the following formula (I) or a salt thereof:

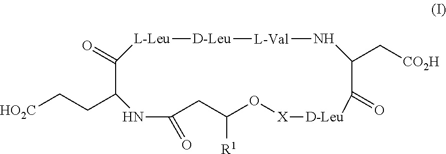

wherein ‘X’ is a residue of an amino acid selected from leucine, isoleucine and valine; and R¹ is a C₉₋₁₈ alkyl group.

[11] The use according to the above [9] or [10], wherein the inorganic nanoparticle is a carbon nanotube, a carbon nanofiber or a metal oxide nanoparticle.

[12] The use according to any one of the above [9] to [11], wherein a concentration of the cyclic lipopeptide biosurfactant in the inorganic nanoparticle dispersion liquid is 0.0005 mass % or more and 1 mass % or less.

### Effect of the Invention

A cyclic lipopeptide biosurfactant used in the present invention can remarkably improve the dispersion stability of an inorganic nanoparticle. As a result, by using a cyclic lipopeptide biosurfactant as a surfactant in an inorganic nanoparticle dispersion liquid, the dispersion stability of the inorganic nanoparticle dispersion liquid becomes excellent or an amount of a surfactant to be used can be reduced. In addition, a cyclic lipopeptide biosurfactant is safe to a living body, since the biosurfactant is a peptide compound. Furthermore, the load imposed on the environment by the biosurfactant is small, since the biosurfactant is easily biodegraded. The present invention is therefore industrially very useful, since the present invention can provide an inorganic nanoparticle dispersion liquid having excellent dispersion stability and safety.

### MODE FOR CARRYING OUT THE INVENTION

First, each of step of the present invention method is described hereinafter.

1. Mixing Step

In the present invention, the dispersion stability of an inorganic nanoparticle in a medium is improved by a cyclic polypeptide biosurfactant. In the present invention, the components are therefore mixed first.

A material of an inorganic nanoparticle is not particularly restricted as long as the material is an inorganic substance which is not dissolved in a medium, and is exemplified by carbon material such as a carbon nanotube, a carbon nanofiber, graphene, fullerene, diamond and carbon black; a metal such as Ag, Au, Si, SiC and TiC; a metal oxide such as Al₂O₃, CuO, Cu₂O, Fe₂O₃, Co₃O₄, Ti₂O, ZnO, ZrO₂ and CeO₂; a combined metal oxide such as ZnO.Fe₂O₃, MgO.Fe₂O₃, Au.Co₃O₄, In₂O₃.SnO₂, Sb₂O₃.SnO₂ and Ca₁₀ (PO₄)₆ (OH)₂.

The term “nano” in an inorganic nanoparticle means that the particle is sufficiently fine to constitute a dispersion liquid by a certain means, and does not strictly means that all of the diameter of the particles must be less than 1 μm. For example, a particle size distribution of the particle is measured in an ordinary condition using a laser diffraction particle size measuring device, and the average particle diameter calculated from the measured data may be less than 1 μm and a particle having a size of 1 μm or more may be contained. However, it is preferred that the measurement values of the diameters of all particles are less than 1 μm. An average particle diameter obtained by the above-described method is exemplified by volume average particle diameter, number average particle diameter, area average diameter and the like. In the present invention, the kind of average particle diameter is not particularly restricted, and it is preferred that volume average particle diameter is used as the average particle diameter.

A mixing ratio of an inorganic nanoparticle is not particularly restricted and may be appropriately adjusted. For example, the mixing ratio to a total amount of an inorganic nanoparticle, a cyclic lipopeptide biosurfactant and a medium may be adjusted to 0.0001 mass % or more and 5 mass % or less. When the mixing ratio is 0.0001 mass % or more, it is considered that an inorganic nanoparticle can sufficiently exert the effect in the obtained dispersion liquid. On the one hand, when the ratio is excessively high, an inorganic nanoparticle may possibly settle out in the dispersion liquid; therefore, the ratio is preferably 5 mass % or less. The ratio is preferably 0.0005 mass % or more, more preferably 0.001 mass % or more, even more preferably 0.005 mass % or more, particularly preferably 0.01 mass % or more, and preferably 2 mass % or less, more preferably 1 mass % or less, even more preferably 0.5 mass % or less, particularly preferably 0.1 mass %.

A cyclic lipopeptide biosurfactant is a cyclic peptide compound which has a lipophilic group such as a long-chain alkyl group and which has a surfactant activity. The present invention provides an inorganic nanoparticle dispersion liquid having higher dispersion stability due to a cyclic lipopeptide biosurfactant on the basis of the knowledge that the dispersion stability of an inorganic nanoparticle is remarkably improved by a cyclic lipopeptide biosurfactant. Alternatively, when the present invention provides an inorganic nanoparticle dispersion liquid having a dispersion stability in the similar degree to that of conventional dispersion liquid, an amount of a cyclic lipopeptide biosurfactant as a surfactant can be reduced. In addition, a cyclic lipopeptide biosurfactant has advantages of very high biodegradability and little negative influence on a living body and the environment, since the biosurfactant is a peptide compound.

A cyclic lipopeptide biosurfactant is not particularly restricted as long as the biosurfactant has a bulky cyclic structure and is a peptide compound having a surfactant activity, and is exemplified by surfactin, arthrofactin, iturin, serrawettin, lichenysin and viscosin.

In the present invention, surfactin (I) or a salt thereof may be preferably used as a cyclic lipopeptide biosurfactant.

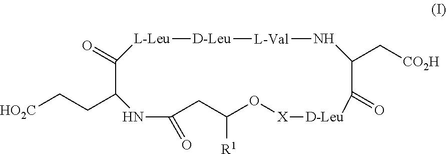

wherein ‘X’ is a residue of an amino acid selected from leucine, isoleucine and valine; R¹ is a C₉₋₁₈ alkyl group.

Although the amino acid residue as ‘X’ may be in either a L-form or a D-form, the L-form is preferred.

The term “C₉₋₁₈ alkyl group” means a linear or branched monovalent saturated hydrocarbon group having 9 or more and 18 or less carbon atoms. The example thereof includes n-nonyl, 6-methyloctyl, 7-methyloctyl, n-decyl, 8-methylnonyl, n-undecyl, 9-methyldecyl, n-dodecyl, 10-methylundecyl, n-tridecyl, 11-methyldodecyl, n-tetradecyl, n-pentadecyl, n-hexadecyl, n-heptadecyl and n-octadecyl.

Either one of surfactin (I) may be used, or two or more surfactin (I) may be combined to be used. For example, two or more surfactin (I) of which C₉₋₁₈ alkyl groups are different may be used.

Surfactin (I) can be obtained by a conventionally known method. For example, surfactin (I) can be isolated from a culture broth prepared by cultivating a microorganism such as a strain belonging to Bacillus subtilis in accordance with a known method. The surfactin (I) may be a purified product or an unpurified product. For example, a culture broth may be directly used as the unpurified product. Alternatively, a product obtained by a chemical synthesis method may be similarly used.

The counter cation which constitutes the salt of surfactin (I) is not particularly restricted and exemplified by an alkali metal ion and an ammonium ion.

An alkali metal ion for the salt of surfactin (I) is not particularly restricted and exemplified by a lithium ion, a sodium ion, a potassium ion or the like. When two or more alkali metal ions are used, the ions may be the same as or different from each other.

The example of a substituent of an ammonium ion includes an organic group, for example, an alkyl group such as methyl, ethyl, n-propyl, isopropyl, n-butyl and t-butyl; an aralkyl group such as benzyl, methylbenzyl and phenylethyl; and an aryl group such as phenyl, toluyl and xylyl. An ammonium ion is exemplified by a tetramethylammonium ion, a tetraethylammonium ion and a pyridinium ion.

In the salt of surfactin (I), two counter cations may be the same as or different from each other. In addition, one carboxy group may be in the state of —COOH or —COO⁻.

An amount of a cyclic lipopeptide biosurfactant to be contained is not particularly restricted, and may be appropriately adjusted in the range that the dipersibility of the obtained inorganic nanoparticle dispersion liquid can be certainly secured. For example, the ratio to a total amount of an inorganic nanoparticle, a cyclic lipopeptide biosurfactant and a medium may be adjusted to 0.0005 mass % or more. When the ratio is 0.0005 mass % or more, it is considered that the dispersibility of an inorganic nanoparticle in the obtained dispersion liquid can be sufficiently improved. On the one hand, the upper limit of the ratio is not particularly restricted. However, when the ratio is excessively high, the effect of a cyclic lipopeptide biosurfactant becomes saturated. The ratio may be therefore adjusted to 1 mass % or less. The ratio is preferably 0.001 mass % or more, more preferably 0.005 mass % or more, even more preferably 0.01 mass % or more, particularly preferably 0.02 mass % or more, and preferably 0.5 mass % or less, more preferably 0.1 mass % or less, even more preferably 0.05 mass % or less.

A medium used in the present invention is not particularly restricted as long as the medium is a liquid in an ordinary temperature and an ordinary pressure and can be used for dispersing an inorganic nanoparticle. For example, the medium is exemplified by water and an organic solvent. Such an organic solvent is exemplified by an alcohol medium such as methanol, ethanol and isopropanol; a polyalcohol medium such as ethylene glycol, propylene glycol, diethylene glycol, dipropylene glycol and glycerin; an ether medium such as diethyl ether and tetrahydrofuran; a ketone medium such as acetone; a nitrile medium such as acetonitrile; an amide medium such as dimethylformamide and dimethylacetamide; a sulfoxide medium such as dimethylsulfoxide; a carboxylic acid medium such as formic acid and acetic acid; an ester medium such as ethyl acetate; an aliphatic hydrocarbon medium such as hexane; an aromatic hydrocarbon medium such as benzene, toluene and xylene; a halogenated aliphatic hydrocarbon medium such as dichloromethane and chloroform; and a halogenated aromatic hydrocarbon medium such as chlorobenzene.

As a medium used in the present invention, a mixed medium prepared by mixing two or more mediums. For example, a mixed medium of water and a water-miscible organic medium, such as a mixed medium of water and an alcohol medium, may be used. The term “water-miscible organic medium” means an organic medium which is miscible with water in an arbitrary proportion.

2. Dispersing Step

When the particle diameter of an inorganic nanoparticle is smaller, the surface area thereof is broader and the Van der Waals' forces between particles becomes larger to form an aggregate. In some cases, an inorganic nanoparticle which is dispersed in a dispersion liquid is specifically treated to prevent such agglomeration. For example, in the case of a carbon nanotube, the agglomeration of particles is inhibited by oxidation to give a polarity to the particles.

In the present invention, re-agglomeration can be inhibited due to the action of a cyclic lipopeptide biosurfactant. Even if an inorganic nanoparticle is subjected to agglomeration suppression treatment, the nanoparticle agglomerates to some extent in a condition of a solid. If an inorganic nanoparticle is not subjected to agglomeration suppression treatment, the nanoparticle is in an agglomerated state still more. Accordingly, in the present invention, an inorganic nanoparticle in an agglomerated state is crushed in the mixture of the inorganic nanoparticle, a cyclic lipopeptide biosurfactant and a medium obtained in the above-described mixing step, and dispersed in the medium. As described above, it is difficult that the crushed and dispersed inorganic nanoparticle re-agglomerates due to the action of a cyclic lipopeptide biosurfactant.

The means to disperse an inorganic nanoparticle in a medium is not particularly restricted as long as an agglomerated particle can be crushed by the means. For example, the means is exemplified by ultrasonic treatment, stirring, ball mill, homogenizer, high pressure homogenizer, jet mill and the like.

In the case of ultrasonic treatment, the detailed condition therefor is not particularly restricted and may be appropriately selected so that an inorganic nanoparticle can be sufficiently crushed. For example, an energy of an ultrasonic which is output from an ultrasonic wave generating device and which is radiated to the mixture may be adjusted to 30 W or more and 1000 W or less, and a frequency of the ultrasonic may be adjusted to 20 kHz or more and 100 kHz or less, and a time to radiate the ultrasonic may be adjusted to 10 minutes or more and 5 hours or less.

The inorganic nanoparticle dispersion liquid according to the present invention is produced by the above-described method. In the dispersion liquid, an inorganic nanoparticle is dispersed in a medium with high dispersion stability or an amount of a surfactant to stably disperse an inorganic nanoparticle is reduced due to the activity of a cyclic lipopeptide biosurfactant. In other words, the inorganic nanoparticle dispersion liquid in which a cyclic lipopeptide biosurfactant is mixed in the same amount as that of a conventional surfactant has higher dispersion stability than a conventional inorganic nanoparticle dispersion liquid. In addition, the inorganic nanoparticle dispersion liquid of the present invention which has similar dispersion stability to that of a conventional inorganic nanoparticle dispersion liquid contains a surfactant in a lower amount than that of the conventional inorganic nanoparticle dispersion liquid. Furthermore, the inorganic nanoparticle dispersion liquid of the present invention is very safe, since a cyclic lipopeptide biosurfactant gives little effect on a living body and the environment.

The degree of “dispersion” in the present invention is not particularly restricted. For example, immediately after the above-described dispersing step, the concentrations in the upper part and lower part in a container may be visually similar to each other. The comparison of such concentrations can be accurately conducted by an absorbance measurement as to the wavelength for the contained inorganic nanoparticle.

The “dispersion stability” in the present invention can be evaluated in the following condition. For example, a dispersion liquid is separated into a supernatant part and a precipitation part by centrifugation. An absorbance of the supernatant part is measured at a wavelength for the used inorganic nanoparticle. When the measured value is 25% or more in comparison with the measurement value immediately after the dispersing step, it can be judged that the dispersion stability is high.

The inorganic nanoparticle dispersion liquid of the present invention may contain a component other than an inorganic nanoparticle, a cyclic lipopeptide biosurfactant and a medium.

Other component contained in the inorganic nanoparticle dispersion liquid according to the present invention is not particularly restricted and may be appropriately selected depending on the form of a final product or the like. The other component is exemplified by a polysaccharide thickener such as guar gum and xanthane gum; a cellulose compound such as hydroxypropyl cellulose and carboxymethyl cellulose; a carboxyvinyl polymer such as an acrylic acid polymer and an acrylic acid copolymer; a silicone compound; a colorant; a pH adjuster; a plant extract; a preservative; a chelating agent; a vitamin preparation; a medicinal ingredient such as an anti-inflammatory drug; a fragrance; an ultraviolet absorber; an antioxidant; or the like. The above-described component may be added to be mixed in the above-described mixing step or dispersing step or after any one of step of the mixing step or dispersing step.

The final form of the inorganic nanoparticle dispersion liquid according to the present invention is not particularly restricted, and exemplified by a paint product and an ink product; a product for environmental conservation; a cosmetic product and a toiletry product, such as a sunscreen product, an anhidrotic, cream, gel, lotion, shampoo, a shower and bath product, a deodorant product, an ornamental product, a liquid dentifrice and a mouth rinse; a medical or domestic antiseptic solution for maniphalanx or the like; a textile product; a gum product and a plastic product; a civil engineering product and an architecture product; a paper product and a pulp product; a machine product and a metal product; a cleaning product; a beverage and a food; an agricultural product and a fertilizer product; an information industry product; other industrial detergent; and the like.

The present application claims the benefit of the priority date of Japanese patent application No. 2014-48158 filed on Mar. 11, 2014. All of the contents of the Japanese patent application No. 2014-48158 filed on Mar. 11, 2014, are incorporated by reference herein.

### EXAMPLES

Hereinafter, the present invention is described in more detail with Examples. However, the present invention is not restricted to the following Examples in any way, and it is possible to work the present invention according to the Examples with an additional appropriate change within the range of the above descriptions and the following descriptions. Such a changed embodiment is also included in the technical scope of the present invention.

### Example 1

### Dispersibility of Carbon Nanotube

Into 1500 g of distillated water, 4.4 g of a multi-layer carbon nanotube which was not subjected to oxidation treatment (hereinafter abbreviated to “MWCNT”; “FloTube9000” manufactured by Cnano Technology Limited, average diameter: 10 to 15 nm, average length: 10 nm) was added. To the mixture, 300 W of ultrasonic was radiated using an ultrasonic reaction apparatus (“SR-1500” manufactured by Shinka Industry Co., Ltd.) for 30 minutes to prepare MWCNT pre-dispersion. Then, into 3.4 g of the MWCNT pre-dispersion, 5 mg of surfactin sodium salt (“SFNa” manufactured by KANEKA CORPORATION) was added. Further, distillated water was added thereto so that the total amount was adjusted to 20 g. Into a screw tube, 20 g of the diluted MWCNT pre-dispersion was added. The inside of a tank of an ultrasonic cleaning machine (“WT-600-40” manufactured by HONDA ELECTRONICS CO., LTD.) was filled with an appropriate amount of water, and the screw tube was immersed in the water. MWCNT dispersion liquid was obtained by radiating 480 W of ultrasonic for 40 minutes.

The concentration of the dispersed MWCNT was determined from the absorbance at 700 nm of the MWCNT dispersion supernatant. All of MWCNT was dispersed well immediately after the radiation of ultrasonic, and the concentration of MWCNT was 522 ppm.

The above-described MWCNT dispersion liquid was centrifuged at 9400 G for 10 minutes, and then the absorbance of the supernatant was measured. As a result, the dispersion keeping ratio of MWCNT in the supernatant was 29.0%.

The above-described MWCNT dispersion liquid was allowed to stand still at room temperature for 8 days, and then was visually separated into a supernatant part and a precipitation part. The absorbance of the supernatant was measured; as a result, the dispersion keeping ratio of MWCNT in the supernatant was 79.1%.

1. A method for producing an inorganic nanoparticle dispersion liquid, comprising the steps of:
mixing an inorganic nanoparticle, a cyclic lipopeptide biosurfactant and a medium, and dispersing the inorganic nanoparticle in the medium.

2. The method according to claim 1, wherein surfactin represented by the following formula (I) or a salt thereof is used as the cyclic lipopeptide biosurfactant: 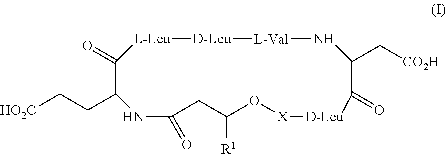
wherein ‘X’ is a residue of an amino acid selected from leucine, isoleucine and valine; and R¹ is a C₉₋₁₈ alkyl group.

3. The method according to claim 1, wherein the inorganic nanoparticle is a carbon nanotube, a carbon nanofiber or a metal oxide nanoparticle.

4. The method according to claim 1, wherein a concentration of the cyclic lipopeptide biosurfactant in the inorganic nanoparticle dispersion liquid is 0.0005 mass % or more and 1 mass % or less.

5. An inorganic nanoparticle dispersion liquid,
comprising an inorganic nanoparticle, a cyclic lipopeptide biosurfactant and a medium, and
wherein the inorganic nanoparticle is dispersed in the medium.

6. The inorganic nanoparticle dispersion liquid according to claim 5, wherein the cyclic lipopeptide biosurfactant is surfactin represented by the following formula (I) or a salt thereof: 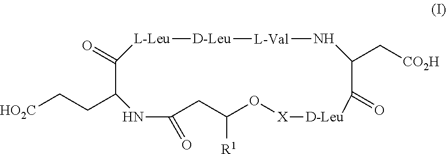
wherein ‘X’ is a residue of an amino acid selected from leucine, isoleucine and valine; and R¹ is a C₉₋₁₈ alkyl group.

7. The inorganic nanoparticle dispersion liquid according to claim 5, wherein the inorganic nanoparticle is a carbon nanotube, a carbon nanofiber or a metal oxide nanoparticle.

8. The inorganic nanoparticle dispersion liquid according to claim 5, wherein a concentration of the cyclic lipopeptide biosurfactant in the inorganic nanoparticle dispersion liquid is 0.0005 mass % or more and 1 mass % or less.

9-12. (canceled)

13. The method according to claim 2, wherein the inorganic nanoparticle is a carbon nanotube, a carbon nanofiber or a metal oxide nanoparticle.

14. The method according to claim 2, wherein a concentration of the cyclic lipopeptide biosurfactant in the inorganic nanoparticle dispersion liquid is 0.0005 mass % or more and 1 mass % or less.

15. The method according to claim 3, wherein a concentration of the cyclic lipopeptide biosurfactant in the inorganic nanoparticle dispersion liquid is 0.0005 mass % or more and 1 mass % or less.

16. The inorganic nanoparticle dispersion liquid according to claim 6, wherein the inorganic nanoparticle is a carbon nanotube, a carbon nanofiber or a metal oxide nanoparticle.

17. The inorganic nanoparticle dispersion liquid according to claim 6, wherein a concentration of the cyclic lipopeptide biosurfactant in the inorganic nanoparticle dispersion liquid is 0.0005 mass % or more and 1 mass % or less.

18. The inorganic nanoparticle dispersion liquid according to claim 7, wherein a concentration of the cyclic lipopeptide biosurfactant in the inorganic nanoparticle dispersion liquid is 0.0005 mass % or more and 1 mass % or less.
